(19) United States
(12) Patent Application Publication
(10) Pub. No.: US 2013/0298759 A1
(43) Pub. Date: Nov. 14, 2013

(54) INTEGRATED MECATRONIC STRUCTURE FOR PORTABLE MANIPULATOR ASSEMBLY

(71) Applicants: Christine Rotinat-Libersa, Le Plessis Robinson (FR); Belen Solano, Zaragoza (ES); Javier Martin, Zaragoza (ES)

(72) Inventors: Christine Rotinat-Libersa, Le Plessis Robinson (FR); Belen Solano, Zaragoza (ES); Javier Martin, Zaragoza (ES)

(21) Appl. No.: 13/876,158

(22) PCT Filed: Sep. 30, 2011
(86) PCT No.: PCT/EP2011/067202

§ 371 Date: May 16, 2013

(30) Foreign Application Priority Data
Sep. 30, 2010 (FR) 10 57946

(51) Int. Cl. F15B 15/10

(52) U.S. Cl. CPC F15B 15/103
USPC 92/90

(57) ABSTRACT

An integrated mecatronic structure for a manipulator assembly with one or more degrees of mobility controlled by one or more actuators can impart to the manipulator assembly a motion activated by control means connected to actuation means, and can include at least one flexible unit consisting of at least one flexible element attached to at least one actuator. The actuator is a volume-change actuator associated with a closely related or local dedicated power unit, including a tank and/or an element for converting the supplied power into another form of energy, able to make the manipulator assembly portable.

### TECHNICAL FIELD

The invention relates to an integrated mecatronic structure enabling motions to be produced, and substantial forces to be applied, whilst limiting spatial constraints and making possible the portability of the manipulator assembly within which it is installed, for example a robotised system.

This invention can, for example, be used in the medical or paramedical field. It can be used to obtain a device enabling surgical operations to be carried out on an organ or a region of the body of difficult access, under minimally invasive conditions. It can also be used to produce artificial joints or limbs.

As examples of minimally invasive surgery, those known under the acronyms SILS (Single Input Laparoscopic Surgery) or NOTES (Natural Orifice Transluminal Endoscopic Surgery) may be cited. In this field of application the invention may enable instruments to be supplied which offer great dexterity in undertaking complex surgical operations and actions in areas of difficult access. These instruments can be used with the support of a view of the scene via an endoscope, or using non-invasive interventional imaging techniques such as ultrasonic probes (ultrasound images), radiography (x-rays), MRI, etc. Their design also enables them to be used in open surgery, to reach areas which are not accessible by straight instruments, or to include a viewing source.

Furthermore, artificial limbs or portable robotised gripping/manipulation devices are required in various contexts: to provide relief for operators, for the sake of increased productivity and responsiveness (increasing work rates), to carry out these operations remotely or in hostile environments, and to compensate for or supplement gripping/manipulation functions when they are not possible.

The fields of application of these robotic systems are, for example:
industrial gripping and manipulation (packaging, selective waste sorting, preparation of orders for Mail-Order Sales, dismantlement, etc.);
humanoid and service robotics (assistance for able-bodied, disabled or elderly persons, etc.);
orthoses or prostheses of upper limbs for elderly or disabled persons, or amputees (for example fingers or hands).

### STATE OF THE PRIOR ART

The systems of this type found in the literature are various, and can be characterised by: their dexterity (kinematics, total number of degrees of mobility, mechanical couplings, if present), their power (forces used in the tasks to be accomplished), their size, their mass, their instrumentation with sensors, but also their portability.

In respect of the application of minimally invasive surgery, a high level of dexterity (a large number of degrees of mobility controlled selectively), combined with a high power level and low encumbrance is required to accomplish tasks, such as for example sutures, cutting, excision, resection, stapling, etc., penetrating within the body of the patient by means of a trocar, or more generally by an incision of very small dimensions (in respect of the natural tracts, as in NOTES, the rectum, for example). In addition, mass and portability are desired criteria to facilitate their manipulation and control by surgeons. Finally, their instrumentation with sensors is a guarantee of safety during the operation.

Concerning the effective accomplishment of varied tasks of gripping and complex manipulation of various objects, versatile, dexterous and powerful robotised grippers are required. Indeed, the objects concerned may be of complex shape, of variable dimensions and mass, and may be fragile, deformable, flexible, wet, soiled, with irregular surface conditions and adhesion properties (clothing, food, boxes, tools, persons, etc.). Mechanical, robotic or more generally artificial fingers and/or hands are good candidates. Whether for their use in industry, or as prostheses, the additional criteria of size and mass are also important to be able to make them portable (by a robot arm or a person). Finally, their instrumentation with sensors is a guarantee of safety for the manipulated objects and/or the user.

A number of robotised instruments or systems are used in minimally invasive surgery.

When they have satisfactory dexterity their use is generally limited to exploring and viewing operating scenes (endoscopes), to supplying solutions or medicines, or to sucking up biological fluids (catheters). Their use for the accomplishment of operating tasks requiring the application of forces to tissues and the accomplishment of skilful local actions is not possible, due to their excessive flexibility, their low degree of positional rigidity, and the low forces able to be applied by the distal tool.

The combination of high power with low encumbrance, and possibly with measurement of the forces applied, is always limited by the technical solutions used. Articulated (and sometimes flexible) systems and cable and pulley transmissions are used, for example, in the Da Vinci robot developed by the company Intuitive Surgical, Inc. or in manual non-motorised instruments such as CambridgeEndo, REALHand® or Radius Surgical System. In these, often costly, systems, the instruments still have relatively large diameters (between 5 and 10 mm), which sometimes makes them unsuitable for operations such as SILS, and the fact that their dexterity is concentrated at the ends of the instruments makes them unusable for carrying out complex surgical operations in an operating area which is of difficult access (for example as in NOTES).

High power compatible with non-rectilinear access is sometimes obtained through the use of fluid actuation. In this case, to power each actuator, a remote fluid unit (compressor and tank) and a network of fluid supply tubes traversing the entire instrument are generally used. But the latter have the disadvantage that they rigidify the system, particularly if the number of degrees of mobility is high, which limits its dexterity, but above all increases its encumbrance. In certain cases (see patent application US2009/0314119), there is a single fluid supply tube, and it uses valves locally to control individually the supply of the actuators controlling the different degrees of mobility, but it still remains a pressurised fluid supply pipe which passes through each joint, rigidifying the instrument and limiting its dexterity.

Concerning artificial hands, there are many systems, distinguished by the mechanical technologies and actuators used. In respect of mechanical technologies, one finds either conventional mechanical technologies of the rigid joints and cable transmissions, tendons, belts and gears type, or the use of flexible joints. The actuators used, all of which enable the criterion of power relating to the applications to be addressed, can be conventional, i.e. of the electromechanical engine or ultrasound type (TUAT/Karlsruhe hand), or fluid, such as pneumatic jacks (UTAH/MIT hand—1983, United States) or pneumatic muscles of the Mc Kibben type.

Hands which have a high number of degrees of mobility actuated independently are the most dexterous. But the use of mechanical technologies and conventional actuators makes these systems extremely expensive, encumbrant and of high mass, which compromises their use in service robotics or as a prosthesis.

The solutions commonly used to reduce encumbrance and/or mass are to reduce the number of joints, degrees of mobility or actuators (as in underactuated hands, such as the single-actuator hand of LMS—1991, France—, the SARAH hand—1999, Quebec—, the TUAT/Karlsruhe hand—Germany, 2000—), or alternatively to introduce couplings between degrees of mobility, but the hands constituted in this manner (including the UB Hand III—2005, Italy—and the DLR-HIT hand—2008, Germany/China—which are of human size, or the DLR-hand III—German Aerospace Center—) then become unsuitable for manipulation since they lack dexterity and remain heavy. Another, artificial, solution is to deploy the motors or actuators away from the operational portion or the joints. These motors can be housed in the palm or the proximal phalanges (DLR Hand II—2003, Germany—and hand of LMS—2006, France—), but due to the conventional mechanical technologies used the size of these hands remains greater than that of a human hand (the ratio is often between 1.5 and 2). They can also be housed in the forearm. This is the case, for example with the Blackfingers hand—Italy—and with the Shadow hand (commercial product of Shadow Robot Company—2004, United Kingdom—) which have a conventional mechanical architecture, actuated by pneumatic muscles of the “Mc Kibben” type deployed remotely in the forearm. In these cases a hydraulic unit (with compressor) which is external, i.e. deployed remotely outside the system, is also used, making it difficult for these systems to be made portable.

The application for which these combined criteria of encumbrance and mass must be met absolutely is that of prostheses. And it is established that the prostheses (of human size) currently on sale are not dexterous: due to the integration limitations of conventional technologies, they accomplish only simple motions of the open/close type (“ElectroHands” of the company Otto Bock, produced by the companies Proteor and TechInnovation, and “i-limb” of the company Touch Bionics).

Another limitation relates to the measurement of the internal and external forces, in order that they may interact with the environment (manipulated objects, contact with human beings, etc.) in a flexible, safe and reliable manner. Satisfactory estimation of the forces requires a high number of sensors. But their integration becomes delicate in the case of complex mecatronic designs (use of cable transmissions). The Shadow hand, which is close to the dexterity of the human hand, has, due to its actuation technology, a natural flexibility which is compatible with gripping flexible or fragile objects. In addition, measurement of the interaction forces through proprioceptive measurement is possible in the actuators used, but since these are remotely deployed in the forearm the force estimation sensitivity (which is required for fine manipulations or fragile objects) is limited by the physical thresholds of the mechanisms and transmissions used in the structure.

To summarise, whatever the application, the manipulator assemblies which currently have the best dexterity are still encumbrant. Indeed, they are reaching the limitations of their technological integration/miniaturisation, which is inherent to a conventional design consisting of complex assemblies including many mechanical/mecatronic elements; with respect to artificial hands, they remain heavy, making them unusable in the applications mentioned above. Reducing size, without impairing force-related performance, is sometimes obtained by remote deployment of the motor and power supply unit (in the support base in respect of surgical instruments, or in the forearm, in respect of robotic hands), which increases their mechanical complexity and does not resolve the problems of overall encumbrance and weight, which are essential if they are to be portable.

The state of the art therefore shows that the manipulator assemblies and robotic systems which are concerned here never incorporate all the following criteria together, but only some of these criteria:
dexterity and versatility (manipulator architecture and sufficiently high number of degrees of mobility to accomplish complex actions),
integration and portability (lesser encumbrance, lightness), in order to be able, for example, to be portable (by a surgeon or more generally a user), integrated in a robot arm (surgical, industrial, humanoid, service), or to constitute an orthosis/prosthesis (of human appearance) which can be adapted to the limb of a person,
generation of relatively high forces (at least of the order of those applied by the surgeon or the human hand),
instrumentation with sensors (measurement of internal forces, perception of forces of interaction with the surrounding environment).

### DESCRIPTION OF THE INVENTION

The present invention has been designed to remedy the disadvantages of the devices of the prior art set out above.

To this end, according to the present invention, an integrated mecatronic structure is provided which can be used in a manipulator assembly with one or more degrees of mobility, where the manipulator assembly is intended to interact with, be positioned on, or introduced into, the body of a patient, and where the integrated mecatronic structure can be actuated selectively from control means by actuation means. It consists of at least one flexible element and at least one actuator attached to the flexible element in such a way that it is able to impart a motion activated by the control means to the flexible element. The actuator is a volume-change actuator, located on the structure (or proximately deployed), and associated with a dedicated power unit (i.e. one which is specific to it). This unit includes a tank and/or an element for converting the supplied power (transducer), and is closely related to the actuator or local, which also enables the manipulator assembly to be made portable. Thus, for example in the case of a volume-change actuator using a pressurised fluid, the supply unit in pressurised fluid supply unit is incorporated locally in the mecatronic structure, and there is no requirement for the manipulator assembly constituted in this manner to be connected to an encumbrant external compressor, via a fluid circuit traversing the entire manipulator assembly as far as the volume-change actuator in question.

One aim of the present invention is to provide, by virtue of this integrated mecatronic structure, a device able to reach an operating area of difficult access (for example, requiring that it passes around other organs, and/or where it must pass through winding natural tracts), or where access is impossible with existing tools or systems (straight tools, or tools limited to a few degrees of mobility at the end of a straight rod, to the detriment of the minimal diameter, of the order of 5 mm).

Another aim of the present invention is to provide a device enabling a complex surgical task (anastomosis, suture, ablation, resection, stapling, manipulation, cutting, including viewing), to be undertaken, made possible by a tool providing great dexterity, with several degrees of mobility (thus extending the surgeon's hand) and with a very small diameter section (less than or equal to 5 mm).

Another aim of the present invention is to provide an effective device which is appropriate for sterilisation and disposable operation, capable of producing relatively powerful forces in a relatively reduced space.

Another aim of the present invention is to provide a device which presents no danger for the surrounding tissues and/or the operated tissues, due to its relative flexibility, combined with measurement of the forces of interaction of the tool with this environment, via proprioceptive and/or exteroceptive measurements, and coupling with an electronic control system to control it and to make it safer for the patient (automatic limitation of the forces applied by the device).

Yet another aim of the present invention is to provide a device which can be manipulated manually by the surgeon, remotely operated via a dedicated physical interface (a master arm, possibly with force feedback), or used assisted by a surgical robot arm.

Another aim of the present invention is to provide a device which is modular, due to the fact that it can consist of an assembly of independent and decoupled elementary cells which can be associated on command, and actuated selectively.

Yet another aim of the present invention is to provide a device enabling a surgical need to be met whilst reducing the operating costs of certain robotised tools, relating to their complex, costly design, which is also inappropriate for sterilisation.

Yet another object of the invention is to provide an artificial limb, by virtue of this integrated mecatronic structure.

A good example of a complex artificial limb is a hand.

In order to be able to overcome the limitations of current artificial hands, and by this means to provide robotic systems for gripping/dexterous manipulation, and which are suitable in particular for the mentioned fields of application, the present invention provides a new mecatronic technological component (a mechanical and actuation/measurement structure) which enables robotic/artificial fingers/hands to be produced having the following performance features simultaneously:
satisfactory dexterity and satisfactory versatility (manipulator architecture and sufficiently high number of degrees of mobility to accomplish complex actions),
a high level of mecatronic integration, enabling the manipulator assembly to made portable (reduced encumbrance of the fingers of the hand, and lightness),
instrumentation with sensors to measure proprioceptive forces (for perception and estimation of the forces of interaction with the surrounding environment),
generation of relatively high forces, combined with structural flexibility.

This technological component is a flexible unit consisting of a flexible structure (which uses deformation of the structural material to accomplish motions) and of at least one localised (or proximately deployed) actuator. The latter is associated with a dedicated power unit, which is closely related or local to it, and which can consist of a tank and a transducer (an element for converting the supplied power). This transducer can be an actuator which converts the supplied power into mechanical energy, or another transducer, which converts power into another form of energy (for example it may be a resistor which transforms electrical energy into thermal energy). The flexible unit, which is chosen in this case to cause a bending motion (i.e. a rotation around an axis which is not parallel to the structure's main axis), may constitute a finger joint. The actuator or actuators can be incorporated in the flexible unit, or proximately deployed (for example, in the phalanges or the palm of a hand). A flexible unit may be combined with flexible elements to produce actuated degrees of mobility, passive (elastic) degrees of freedom, or coupled degrees of mobility. FIGS. 31A and 31B show an example embodiment of a robotic hand, the joints of which consist of flexible units of the bending type.

This technological component therefore enables mecatronic integration to be facilitated (limiting the number of mechanical parts and simplifying the assembly), and therefore makes it possible to obtain systems having a high number of mobilities which are controlled selectively, in order to attain the desired dexterity.

These systems, which are of integrated design, can therefore be compact, light, inexpensive and even visually appealing. They make integrated energy and control and command possible, giving them the portability required for them to be able to be fitted easily to the end of a robot arm, or attached to the end of the arm of a person.

Furthermore, the use of a flexible structure (a structurally monolithic system) enables the functional and reliability problems habitually found in articulated systems and mechanical transmissions (play and friction) to be avoided, and makes it sensitive to external forces. This allows proprioceptive forces to be measured with satisfactory reliability (sensors incorporated as close as possible to the joints). Thus, for example, if the actuator is a volume-change muscle of the fluid type, firstly the mechanical power levels produced are high, and secondly knowledge of the ordered volume change, and measurement of the pressure in the fluid circuit allow, by means of a behavioural model of the flexible structure and of the actuator, the external forces which are applied to the system (interaction with the user and/or the environment) to be estimated accurately.

This enables a relatively powerful system to be obtained, operation of which is reliable and safe, an aim which is sought notably for applications for manipulating fragile objects or for prostheses/orthoses, in which the device must not be dangerous for the user and/or their environment. This safety is obtained by measuring and checking the applied forces and/or the forces of interaction with the user/environment, but also as a result of the natural structural flexibility inherent to the mechanical technology used to build the system.

By using measurement of movements and internal and external forces, the electronic control system also enables control of the fingers/hands to be provided, guaranteeing control of dexterous, reliable and versatile manipulation, which is appropriate for the task.

One object of the invention is an integrated mecatronic structure for a manipulator assembly with one or more degreees of mobility controlled by one or more actuators, which is able to impart to the manipulator assembly a motion activated by control means connected to actuation means, and which may include at least one flexible unit consisting of at least one flexible element attached to at least one actuator,
characterised in that the actuator is a volume-change actuator, associated with a closely related or local dedicated power unit, including a tank and/or an element for converting the supplied power into another form of energy, able to make the manipulator assembly portable.

The actuator may be a volume-change actuator, possibly associated with a closely related or local tank. It may include a sealed, flexible tube, containing a volume-change material, and a sheath or rigidification element surrounding the tube, or embedded in the wall of the tube, and radially constricting the deformation of the tube in a direction transverse to the lengthways axis of the actuator, and in relation with the actuator's lengthways deformation.

The volume-change actuator may be a fluid actuator. A closed tank containing fluid required for operation of the fluid actuator may be deployed remotely, and connected to the actuator by a fluid supply tube, where this tube is flexible. A pressure sensor may be associated with the volume-change actuator to measure the pressure inside the volume-change actuator, and to deduce from it the forces of interaction between the structure and its environment, and/or a deformation sensor may be associated with the flexible element in order to measure its state of deformation, and to deduce therefrom the interaction forces between the structure and its environment.

The manipulator assembly may include at least one additional flexible unit and/or at least one additional flexible element, such that it gives the device several degrees of mobility, where the additional flexible unit or units and the additional flexible element or elements can be associated in series, in parallel or in a tree structure with the flexible unit.

An additional flexible element associated in series, in parallel or in a tree structure with the flexible unit may transmit a torque or a rotary motion to the structure, produced by an actuator. This may be a spring or a flexible shaft.

The flexible element or, possibly, the additional flexible element, may be an element consisting of the fixed arrangement of several shapes of flexible base chosen from among a beam, a bar, a small column, a blade, a tab, a curved beam, a curved bar, a curved small column, a curved blade, a curved tab, an arch, a helix, a spiral and a flexible shaft. For example, an X-shaped flexible base may be obtained by arranging two straight beams connected by their middles, or four straight beams connected at their ends. In this arrangement, each chosen flexible base shape is positioned with an angle of alignment of between 0 and 360° relative to the lengthways axis of the flexible element (or of the flexible structure). The arrangement, the materials and the dimensions of each base shape within the flexible element can be optimised such that the flexible element has sought mechanical performance characteristics, for example in terms of mechanical stiffness, strength and/or transmissible torque and/or amplitude of motion.

The flexible element or, possibly, the additional flexible element can be an element causing a bending motion (i.e. a rotation around an axis not parallel to the main axis of the structure) in the flexible portion of the structure.

The flexible element or, possibly, the additional flexible element can be an element which causes a rotary motion in the flexible portion of the structure.

The flexible element or, possibly, the additional flexible element can be an element which causes a translational motion in the flexible portion of the structure.

The flexible element or, possibly, the additional flexible element can be an element which causes a linked motion in the flexible portion of the structure, combining at least two motions from among the following: a bending motion, a rotation and a translational motion.

The flexible element or, possibly, the additional flexible element can be a surgical tool, for example a clamp.

The flexible element or, possibly, the additional flexible element can be an element constituting a flexible guide.

The actuator, possibly coupled with a mechanical transmission system (for example including a wire, cable, a rod, a spring or a flexible shaft), can be chosen from among a wire or a strip made from a shape-memory alloy, a shape-memory actuator, an electromagnetic motor, a piezoelectric actuator, an ultrasound motor, magnetostrictive actuator and an electroactive polymer.

The structure may also include a rotary joint including a shaft and a volume-change muscle wound in a helix around the shaft, and securely attached, by a first end, to the said shaft and, by a second end, to the structure, where the volume-change muscle is able to cause the shaft to rotate under the effect of a command.

The volume-change actuator and/or its tank can include a syringe, a piston, a jack or a bellows.

The means of actuation or control of the actuator can be chosen from among manual actuation or control means or motorised actuation or control means.

The structure can include at least one flexible unit or one installable, easy-disassembly, disposable or interchangeable flexible element.

The structure can be fitted with at least one external sensor, able to provide information to a user concerning a temperature, an electric current, a motion made or a force produced by a component of the manipulator assembly on its environment. This external sensor may be a sensor chosen from among a single-axis or multiple-axis force sensor measuring a shearing and/or clamping force, or a touch sensor measuring a contact force, exerted by one or more elements of the structure (a surgical tool or another flexible unit of the structure) on its environment (an organ, a region of a patient's body or a manipulated object).

The structure can include a control system receiving data from at least one sensor to control and/or limit the motion and/or forces produced by the device on its environment.

Another object of the invention is a surgical device to accomplish surgical actions requiring great dexterity on an organ or a region of the body of difficult access, and under minimally invasive conditions, including a structure as defined above, where the first end of the structure is a proximal end for the device, and where the structure may include at its distal end a surgical tool and/or a means of exploration able to be actuated from the control means by actuation means.

The means of control of this surgical device can be chosen from among a mechanical or motorised actuation handle, a remote operation interface, possibly with force feedback, or a surgical robot arm.

A viewing means may be attached to the distal end of the structure.

Another object of the invention is an artificial limb including at least one joint including the structure as defined above, where the first end of the structure is a proximal end for a patient or a robot.

The means of control of this artificial limb can then be electronic control means, possibly with force feedback.

The electronic control means can be means using electroencephalography techniques and/or signals, and/or electromyography techniques and/or signals.

### BRIEF DESCRIPTION OF THE ILLUSTRATIONS

The invention will be better understood and other advantages and features will appear on reading the following description, which is given as a non-restrictive example, accompanied by the appended illustrations, among which:

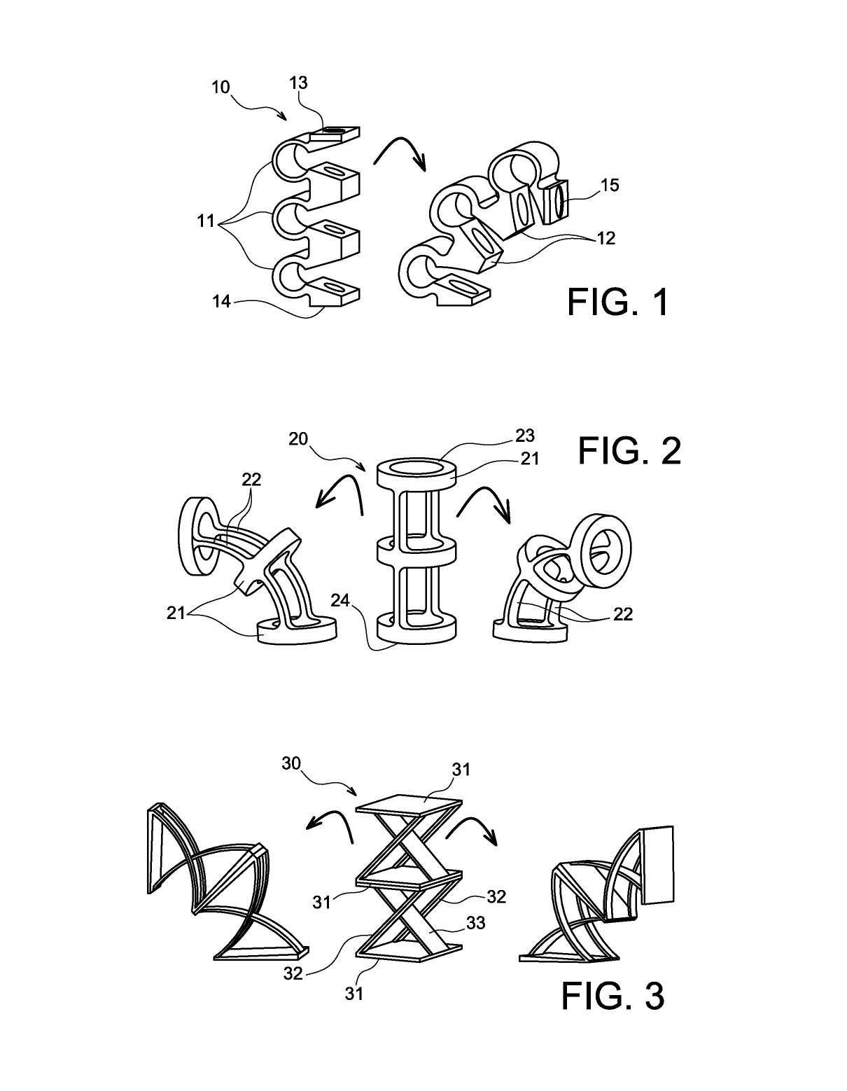

FIG. 1 represents a flexible element which may be used, in the flexible structure according to the invention, to impart a unidirectional bend with one degree of mobility,

FIG. 2 represents a flexible element which may be used, in the flexible structure according to the invention, to impart a bidirectional bend with one degree of mobility,

FIG. 3 represents a flexible element which may be used, in the flexible structure according to the invention, to impart a bidirectional bend with one degree of mobility,

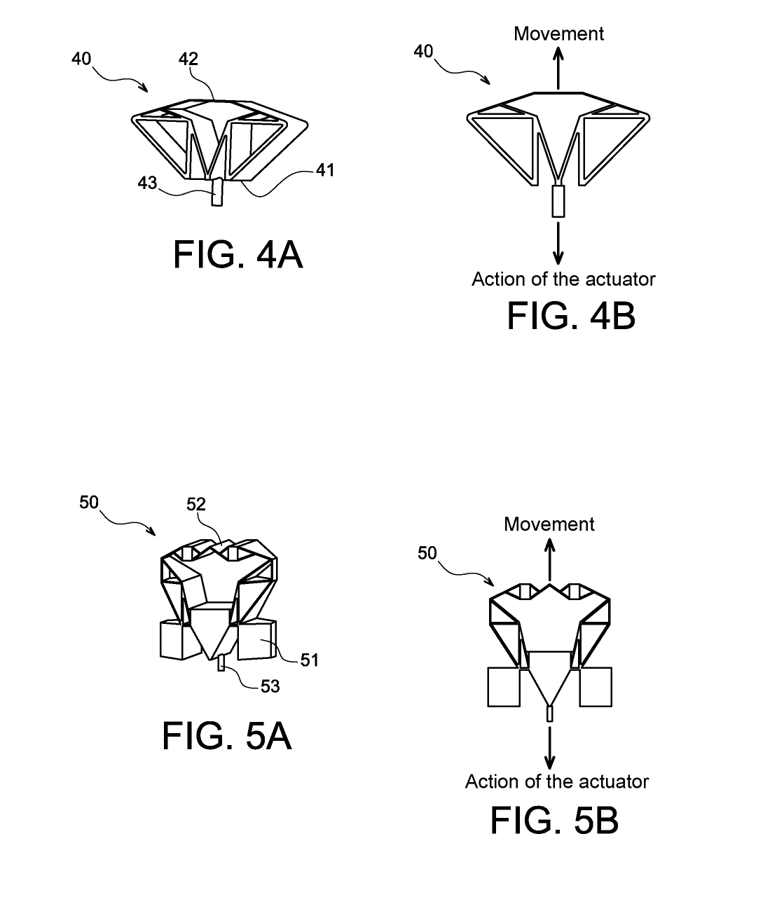

FIGS. 4A and 4B illustrate a first example of a flexible element enabling the flexible structure according to the invention to be imparted with a degree of translational mobility along the lengthways axis of the device,

FIGS. 5A and 5B illustrate a second example of a flexible element enabling the flexible structure according to the invention to be imparted with a degree of translational mobility along the lengthways axis of the device,

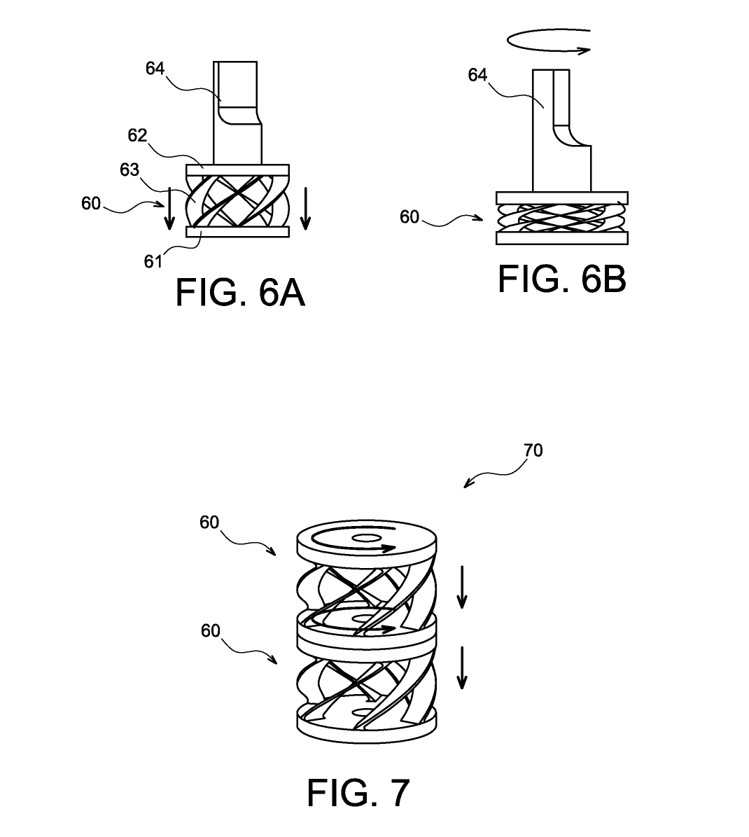

FIGS. 6A and 6B illustrate a first example of a flexible element able to be used in the flexible structure according to the invention to impart it with an intrinsic degree of rotary mobility of finite angle,

FIG. 7 illustrates a second example of a flexible element able to be used in the flexible structure according to the invention to impart it with an intrinsic degree of rotary mobility of finite angle,

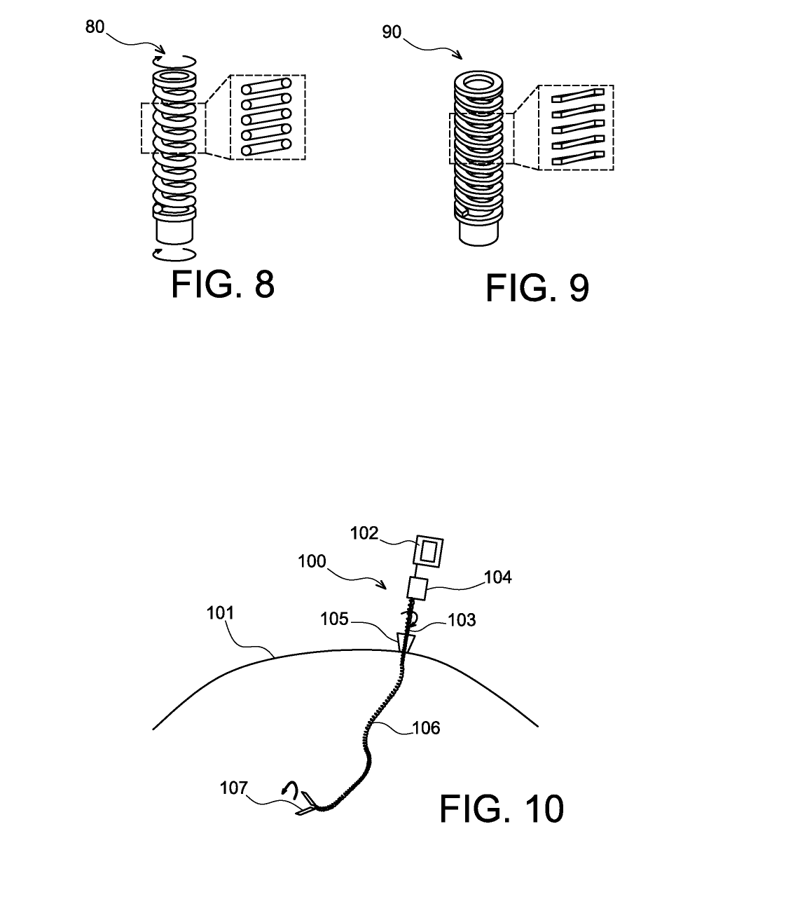

FIGS. 8 and 9 each show a flexible element able to be used in the flexible structure according to the invention, and consisting of a helical spring allowing a torque or a rotation of infinite angle to be transmitted, produced by an actuator not belonging to a flexible unit, along the flexible structure and through other flexible units or elements, without any coupling or disturbances,

FIG. 10 shows a surgical device according to the invention in use on a patient,

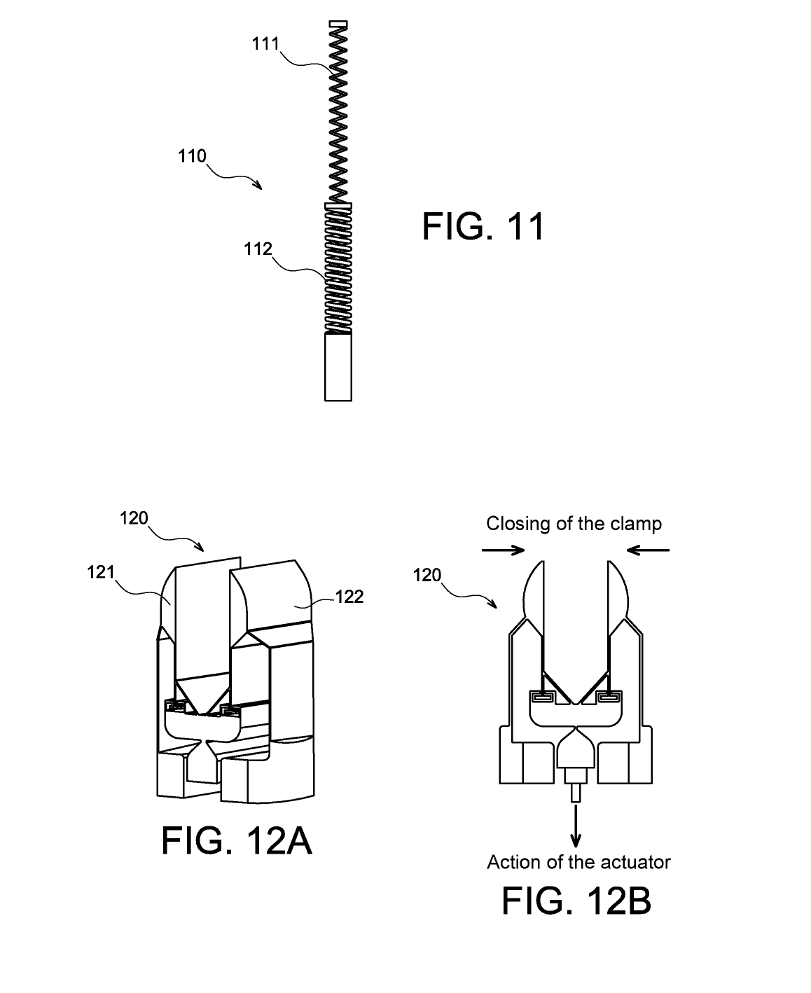

FIG. 11 represents another example of flexible elements able to be used in the flexible structure according to the invention for the decoupled transmission of two rotations or torques, produced by actuators not belonging to a flexible unit, in coaxial fashion,

FIGS. 12A and 12B illustrate a model of a flexible clamp able to be used in the surgical device according to the invention,

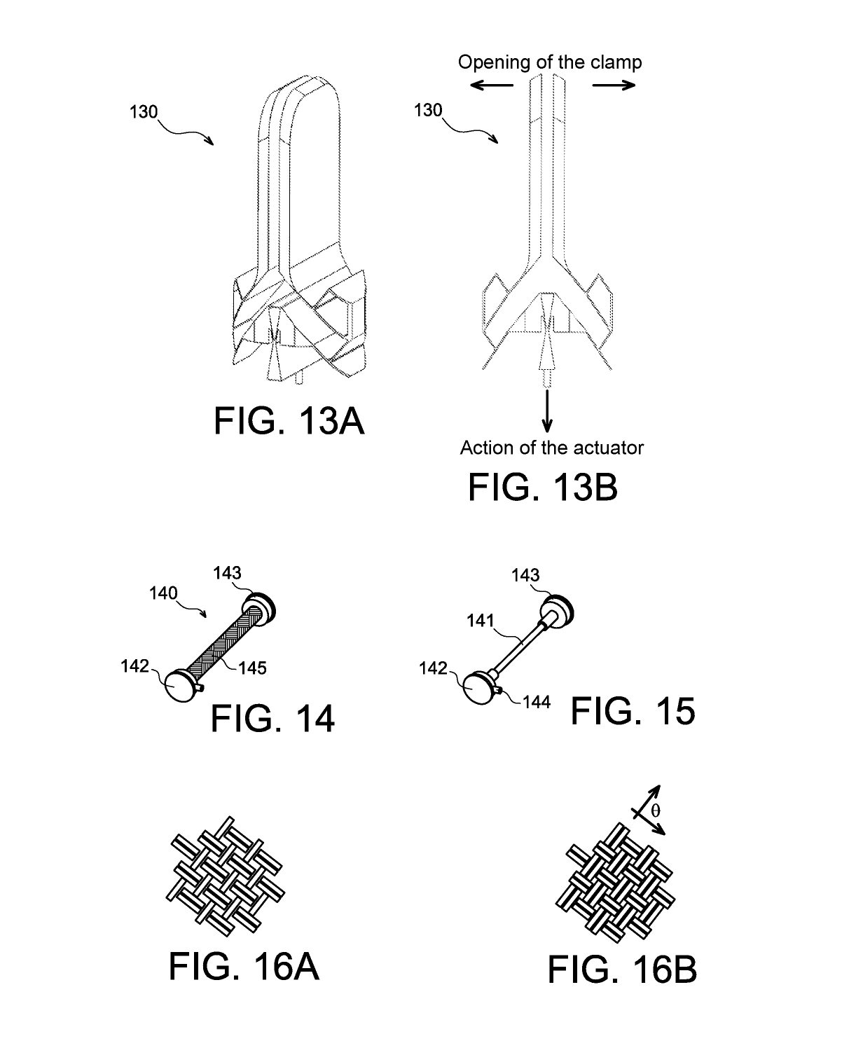

FIGS. 13A and 13B illustrate a model of a flexible needle-holder able to be used in the surgical device according to the invention,

FIG. 14 represents, seen from a perspective view, a McKibben-type fluid muscle,

FIG. 15 represents a detail of the fluid muscle represented in FIG. 14,

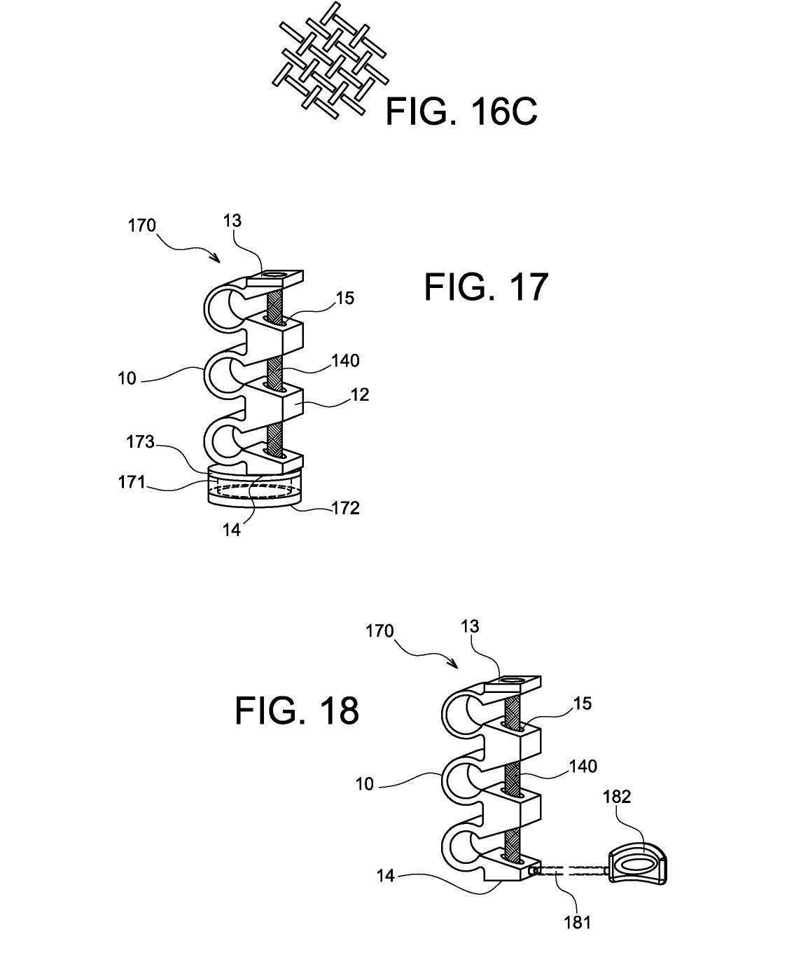

FIGS. 16A to 16C show examples of braids able to be used for the fluid muscle represented in FIG. 14,

FIGS. 17 and 18 show two possible configurations of the power unit of a volume-change actuator of the fluid type, one closely related to the actuator, the other remotely deployed, for controlling the motion of the element described in FIG. 1, where the volume-change actuator is, in this case, a McKibben-type fluid muscle,

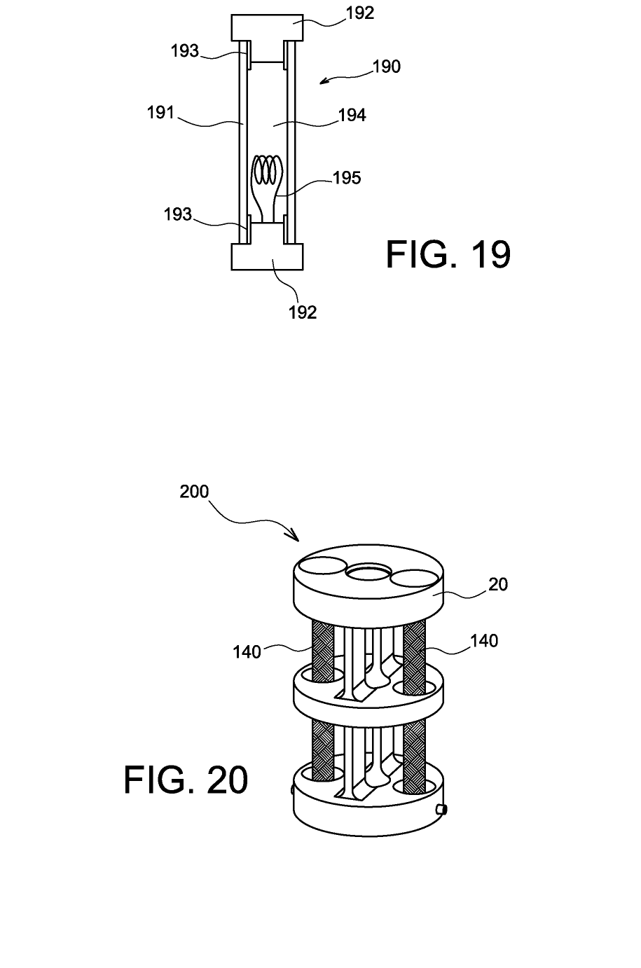

FIG. 19 is a lengthways section view of a volume-change actuator, containing a volume-change material the volume of which is changed by heating using an electric resistor placed inside the actuator, able to be used for the mecatronic flexible structure according to the invention,

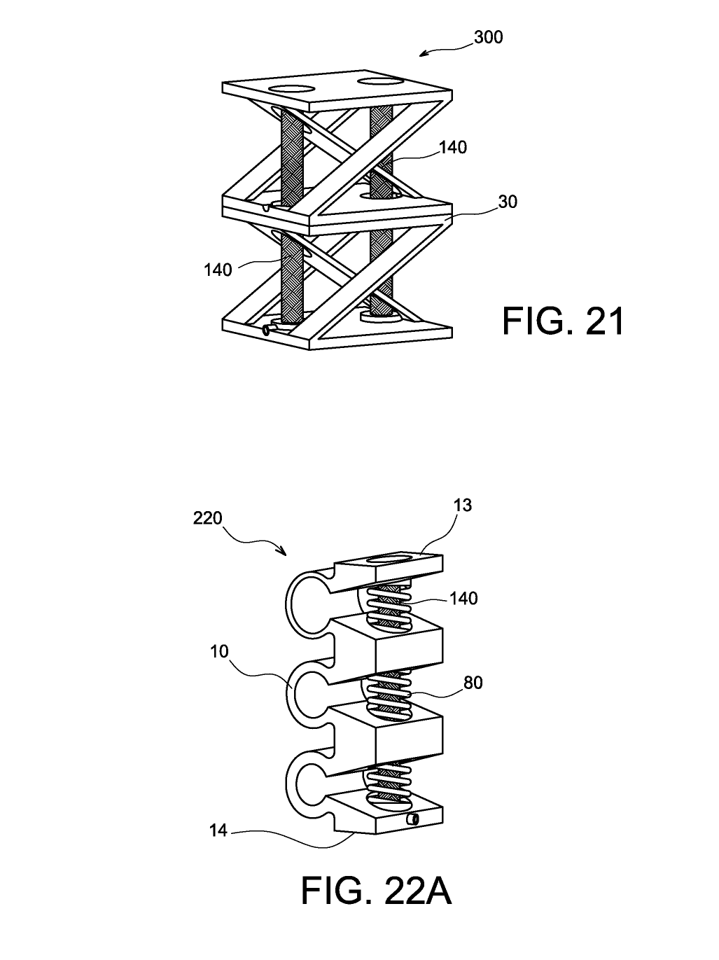

FIGS. 20 and 21 show flexible units consisting of flexible elements fitted with two McKibben-type fluid muscles, able to be used for the mecatronic flexible structure according to the invention,

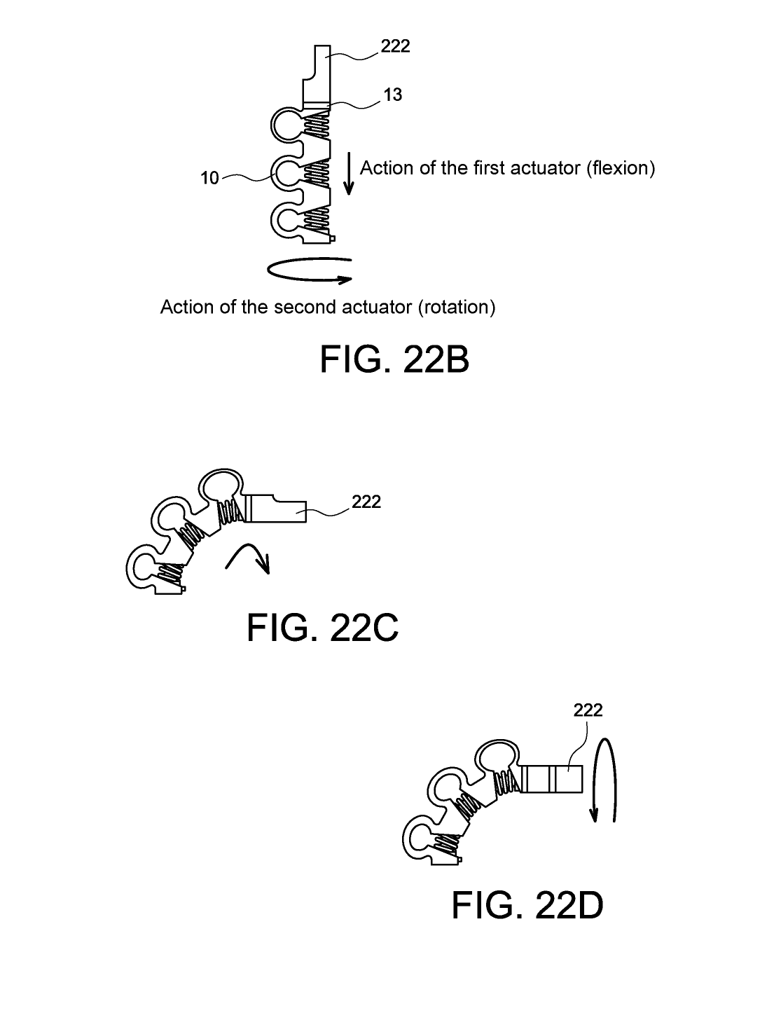

FIGS. 22A to 22D illustrate a flexible unit with two degrees of mobility (a bending action and a distal rotation), able to be used for the mecatronic flexible structure according to the invention,

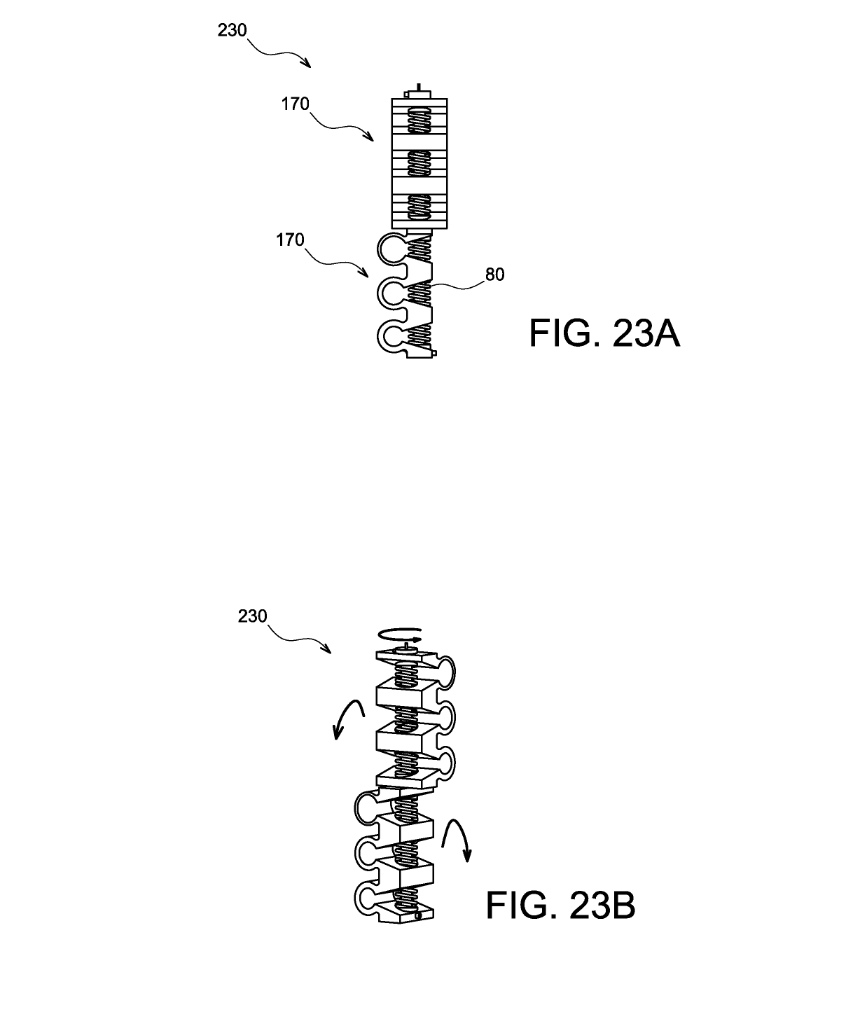

FIGS. 23A and 23B show two flexible units, each having a degree of (bending) mobility, connected in series, through which passes a device for transmitting a distal rotation, to form an assembly able to be used for the mecatronic structure according to the invention,

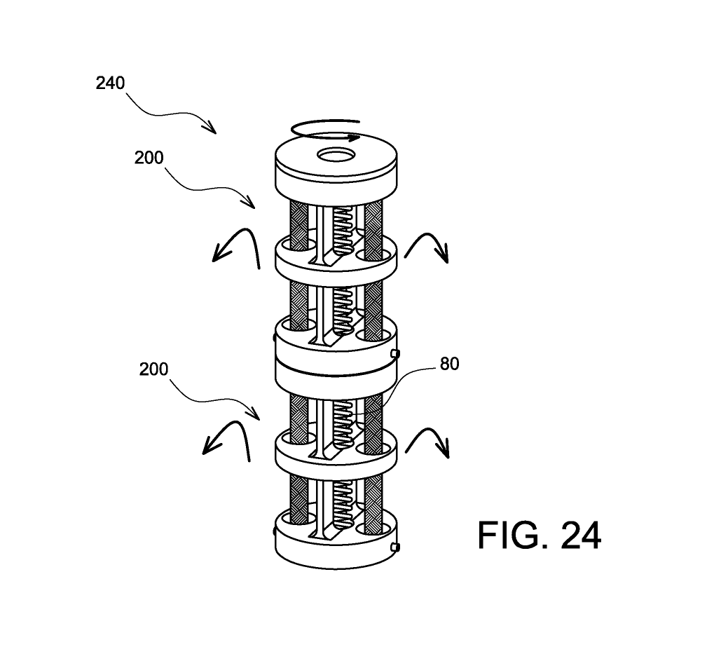

FIG. 24 shows another example of two independent flexible units connected in series to form an assembly able to be used for the mecatronic flexible structure according to the invention, through which passes a device for transmitting a distal rotation,

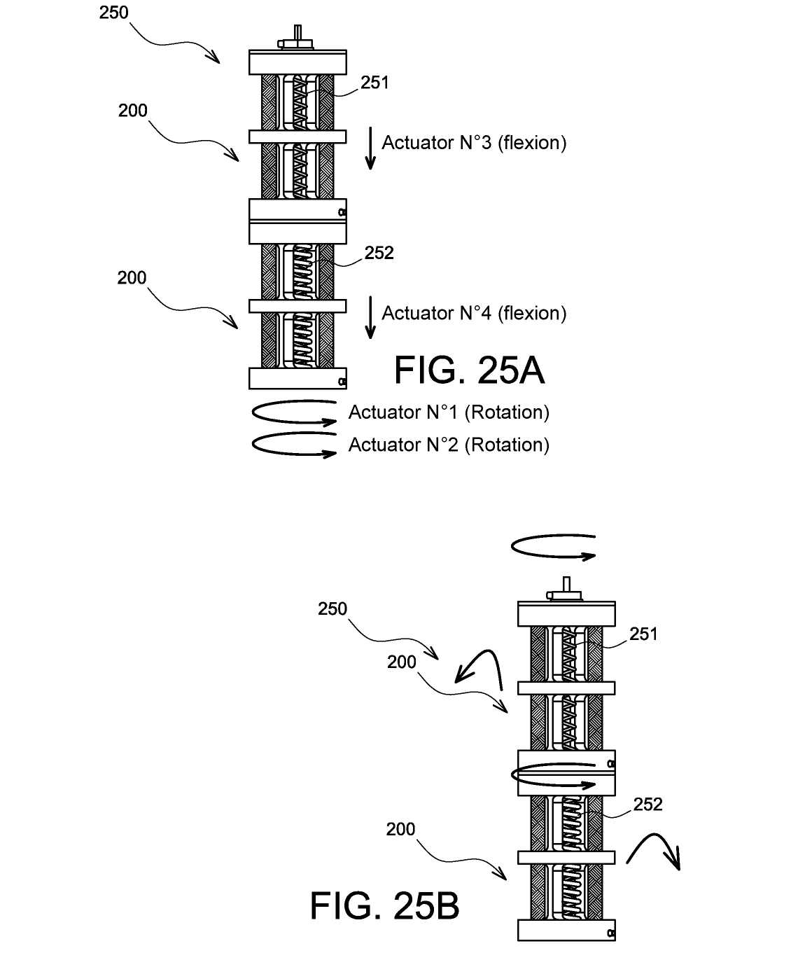

FIGS. 25A and 25B show two other independent flexible units connected in series to form an assembly able to be used for the mecatronic flexible structure according to the invention, through which pass a device for transmitting a rotation of the second unit relative to the first unit, and a device for transmitting a distal rotation,

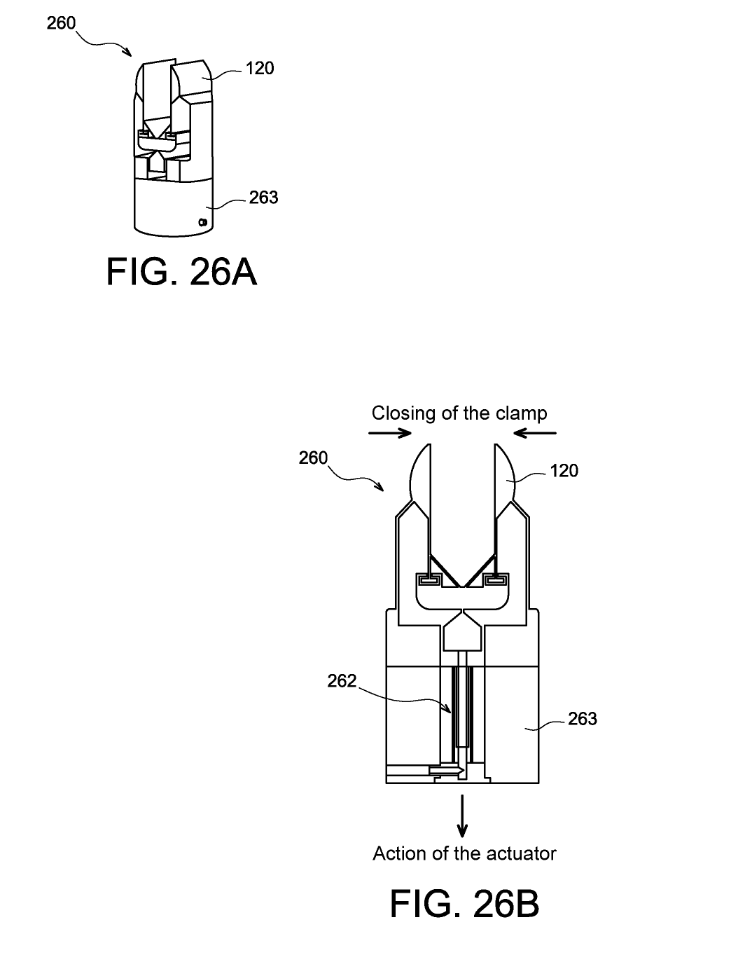

FIGS. 26A and 26B represent a flexible unit of the tool type including a flexible clamp and its actuator, able to be used in the surgical device according to the invention,

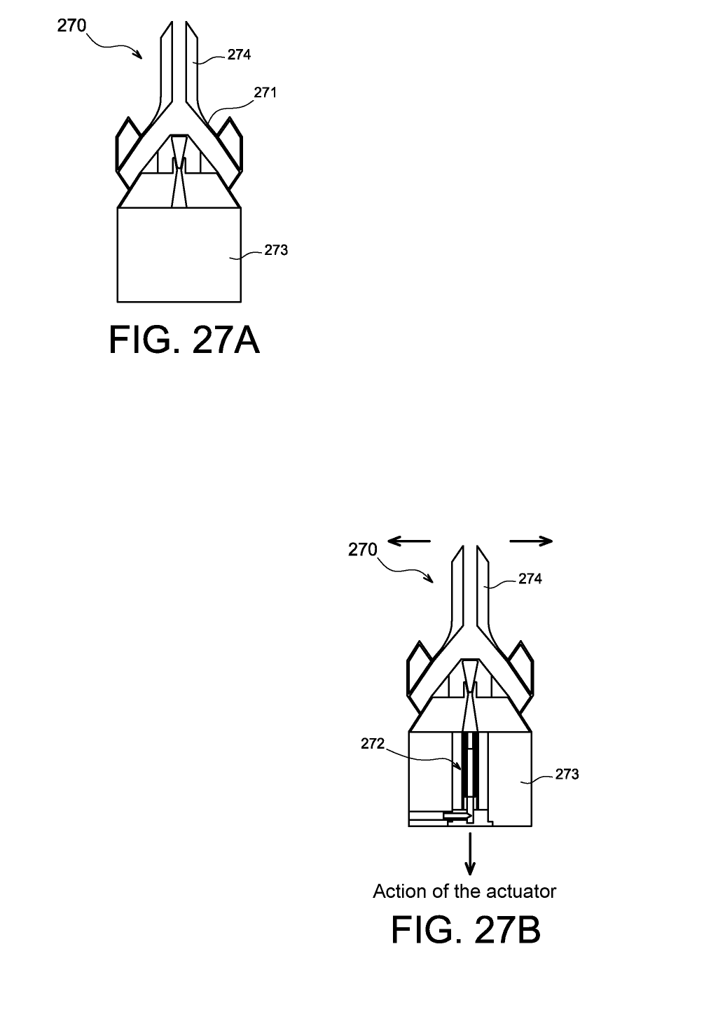

FIGS. 27A and 27B represent a flexible unit of the tool type including a flexible needle-holder and its actuator, able to be used in the surgical device according to the invention,

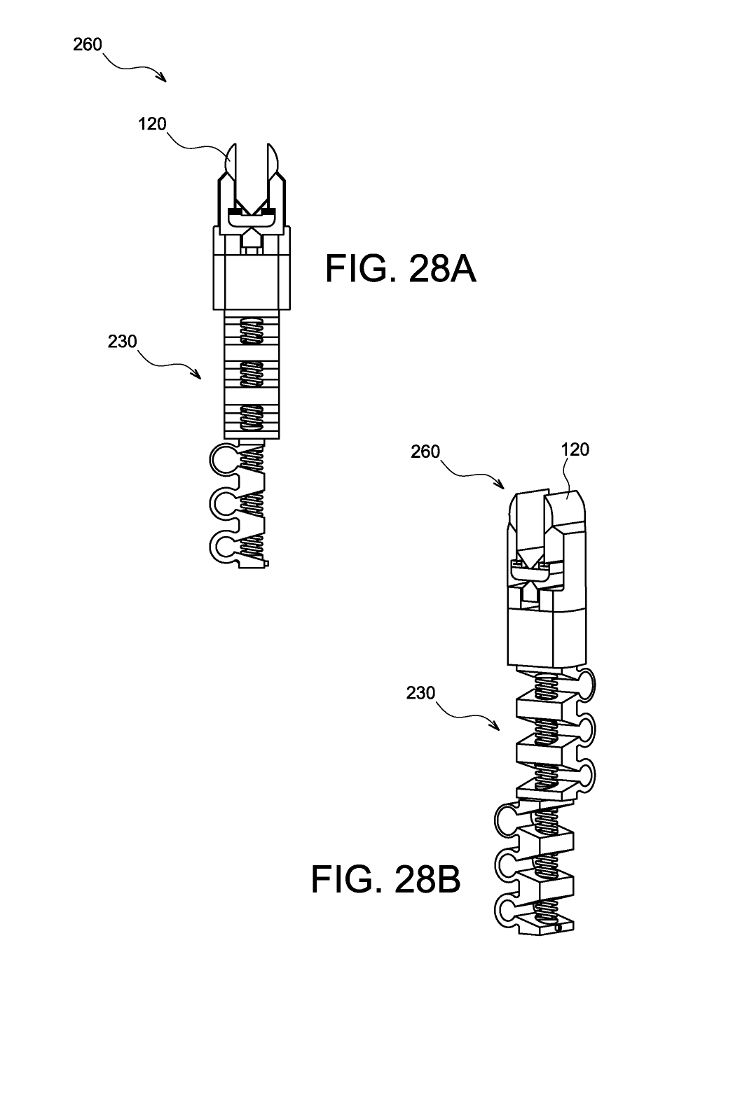

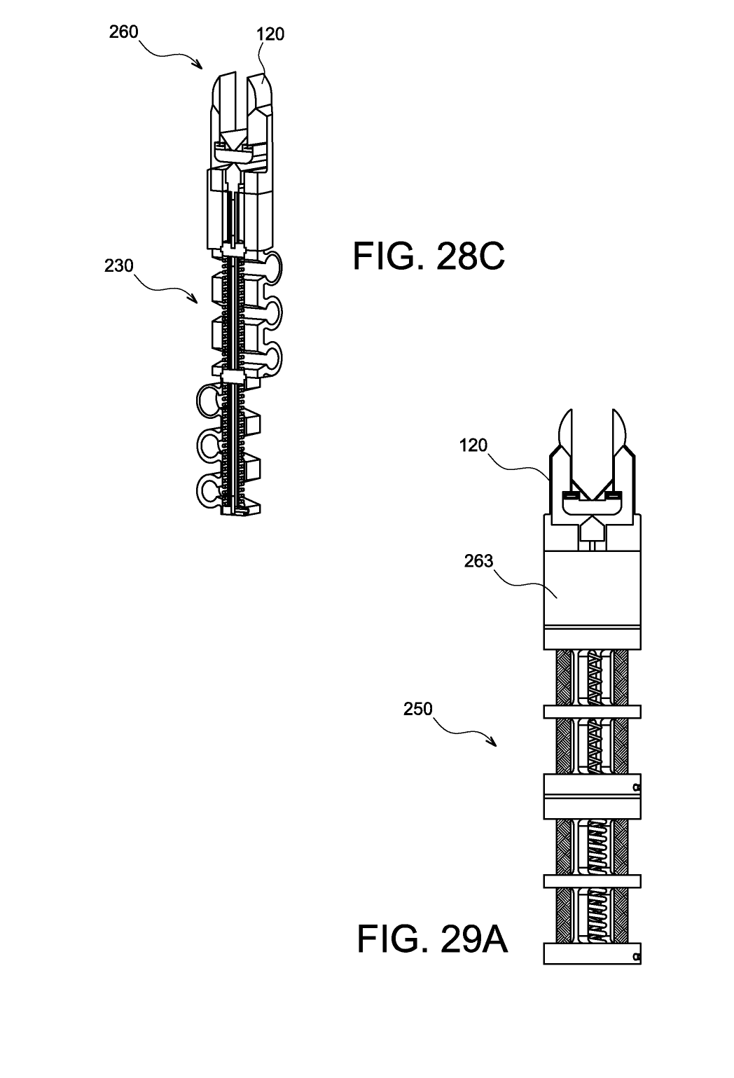

FIGS. 28A to 28C represent different views of a portion of a surgical device according to the present invention, having two degrees of unidirectional bending mobility and transmission of distal rotation of infinite angle, and at its end a flexible clamp with its actuator,

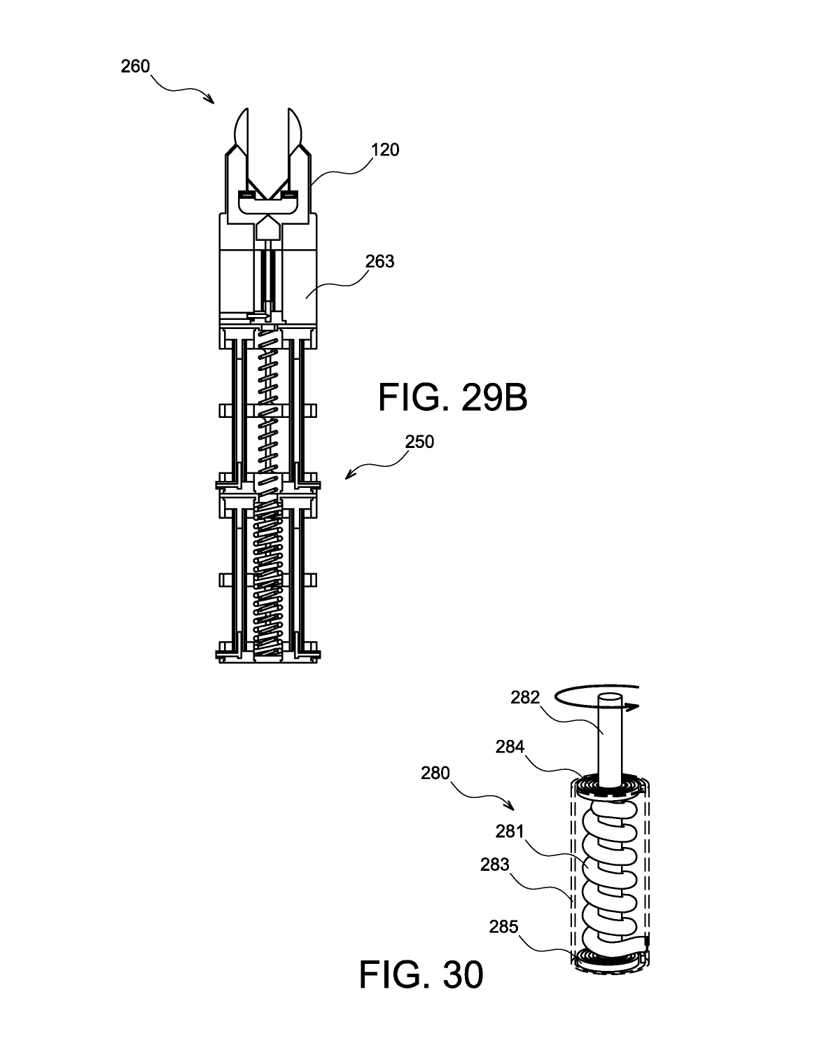

FIGS. 29A and 29B represent a portion of a surgical device according to the present invention, having two degrees of bidirectional bending mobility, a transmission of intermediate rotation and a transmission of distal rotation, both of infinite angle, and at its end a flexible clamp with its actuator,

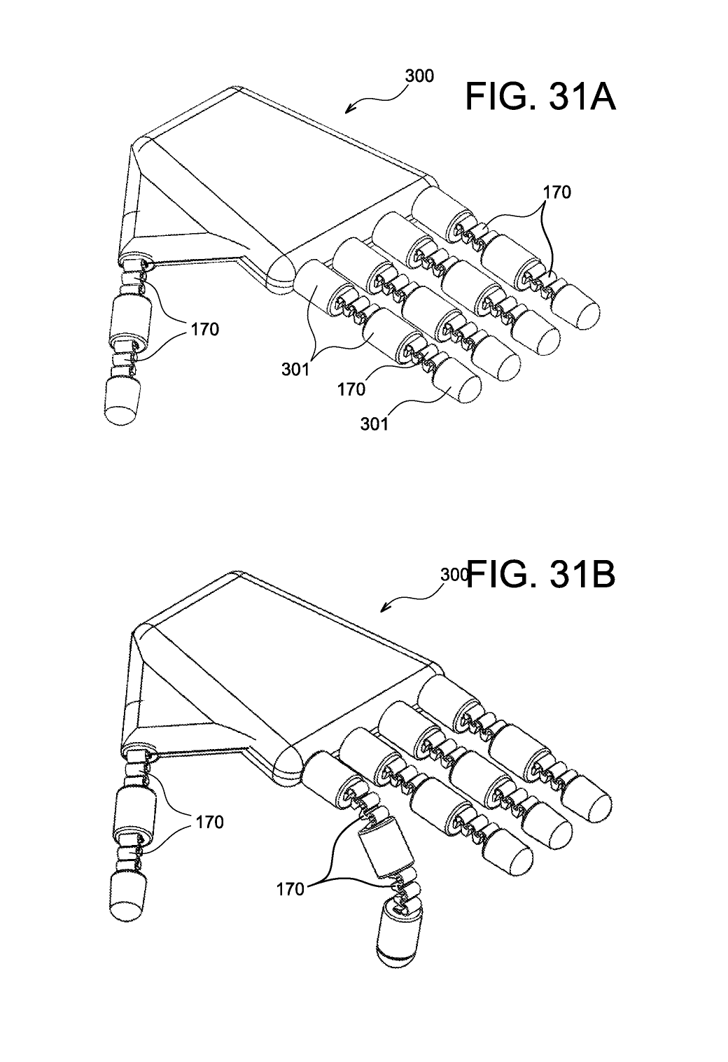

FIG. 30 represents a flexible unit with a degree of rotational mobility of finite angle able to be used in the mecatronic flexible structure according to the present invention,

FIGS. 31A and 31B represent an artificial hand according to the present invention: FIG. 31A represents the artificial hand with stretched fingers, whilst FIG. 31B represents the artificial hand with a slightly bent finger.

### DETAILED ACCOUNT OF PARTICULAR EMBODIMENTS

The invention will firstly be described in its application to the constitution of a surgical device to accomplish surgical actions requiring great dexterity on an organ or a region of the body of difficult access, and under minimally invasive conditions. It will then be described in its application to the production of an artificial hand.

The new joints and the distal tools of the device are obtained through the use of flexible structural elements, to replace conventional mechanical joints (which are generally constituted by rigid parts connected to one another to obtain relative motion). These elements enable bends through large angles which may even exceed 90° to be produced, rotations, translational motions, or any other motion. The materials used to produce these flexible elements can be metallic, polymer, superelastic, shape-memory or intelligent materials, etc. These new joints and these distal tools can remain passive, or be actuated. Assembly of the device during its manufacture is facilitated, since the flexible elements can be produced from a single block of material (by machining or casting); the term given to this is “monolithism”.

The actuators are not necessarily remotely deployed to the base of the device, but can also be located in proximity to the flexible elements. The term used for this is then “flexible units of the joint or tool type”. The actuators used can be volume-change actuators. Fluid actuators are particular volume-change actuators. These fluid actuators include, for example, pistons, jacks or actuators of the McKibben type. Volume-change actuators enable high mechanical power to be provided, which is compatible with the forces to be provided, in comparison with more conventional actuators, which for the same encumbrance do not provide sufficient forces. When they are fluid they can satisfy high sterility constraints, due to the materials used and the possible use of physiological fluid. The use of sensors to sense the pressure of the fluid contained in the actuator's hydraulic circuit also enables the actuator's proprioceptive forces to be measured, the characteristic (the response) of which enables the interaction forces of the intracorporeal portion of the device with its environment to be estimated.

These fluid actuators can each be supplied by a linked dedicated closed fluid circuit (or a pressurised fluid supply unit), whether closely related, local or remotely deployed (no use of a compressor external to the tool, or of feed pipes traversing the manipulator assembly), and possibly consisting of a tank, which can be controlled by a mechanical action of the surgeon (for example, through a syringe), or through the use of different types of integrated actuators. This system can be localised (or closely related) to each joint, or incorporated in another portion of the device (proximately deployed in the rod, the handle, etc.). This power unit, and/or its tank, can therefore be integrated, which also enables the device to be made portable.

As a variant, the fluid can be replaced by a volume-change material, for example a wax, which can therefore be contained in the actuator and/or the tank of its dedicated supply unit, if present.

Another variant is to use a localised or remotely deployed actuator, connected to the flexible element through a transmission mechanism (for example a rod, a cable or a rotation/torque transmission spring, etc.), or an actuator of the wire or strip type made of a shape-memory alloy. The flexible elements can also be directly made of active material (for example a material with a shape memory), and can thus incorporate the actuation function directly in the mechanical structure, the power supply generally being electric.

A flexible unit of the joint or tool type (consisting of a flexible structural element and an actuator) constitutes a basic element which can be associated easily (“plug-in”) with other flexible units or flexible elements in different ways, and in different combinations, to obtain a chosen motion, or the desired dexterity, in accordance with the sought application and/or to constitute a versatile instrument, particularly when the actuator is a volume-change actuator, and when its power unit is closely related or local.

### Description of a Surgical Device

The solution proposed by the invention, notably due to the closely related and/or integrated location of the actuator and/or its supply unit (wholly or partly), enables high mobility, as found in systems of the endoscope type, which can conform with the winding geometry of the interior of the human (or animal) body to be operated, to be combined with the mechanical power habitually supplied by surgical or medical tools of straight conventional design (using rigid joints and transmissions by cables or connecting rods), whilst having a very small diameter section (with potential for reduction of scale), allowing minimally invasive access, through incisions made by trocars but also through natural tracts (transluminal tracts).

The closely related and/or integrated location of the actuator and/or its supply unit, enables losses, disturbances and interferences due to the couplings and physical limitations of existing mecatronic systems with remotely deployed actuators or supply unit to be greatly reduced, such that the technical solution proposed by the invention also enables much finer measurement by proprioception, and also by exteroception, of the device's forces of interaction with the tissues. Coupled with an electronic control system enabling the forces applied by all or part of the device to its environment to be limited automatically, this makes the system safer for the patient (limitation of a clamp's clamping forces, limitation of the device's forces of contact with the wall of an organ, etc.). Coupled with a control handle or, more generally, a physical command interface with force feedback, this makes the system easier to use by the surgeon (who thus regains some of the sensory information lost due to the mechanical losses, disturbances and interferences produced through use of the laparoscopic instruments of conventional design).

Flexible elements of the helical spring type (or of the bellows, flexible sleeve type, etc.) can be used to transmit a rotation or torque from the base of the device to the base of a chosen unit or element (joint number “n” or distal tool) through any number, which may be a high one, of intermediate flexible units or elements. Several of these rotations may be considered, but their number will be limited by the encumbrance caused by incorporating the different springs in parallel or coaxial fashion. These flexible elements enable very high angle rotations (several complete rotations, or infinite) to be transmitted, limited only by the motor or actuator controlling the motion.

The mecatronic structure can be fitted with a clamp or a needle-holder, for example. These sterile/sterilisable elements can be added during manufacture or during use in the operating theatre. This concept therefore also enables interchangeable or disposable (through factory sterilisation), and potentially low-cost, end effectors to be produced.

The tools installed at the end of the device can be conventional tools, or flexible units or elements of the tool type, having a flexible structure (clamp, needle-holder, scissors, etc.), actuated locally or remotely by the same type of actuators as those of the flexible units of the joint type).

Finally, the device can either be manipulated manually by the surgeon (a device installed at the end of a control handle), or remotely operated via a dedicated physical interface (master arm), or used installed at the end of a surgical robot arm (possibility of computer-assisted control).

One of the applications sought by the present invention is the accomplishment of various actions in minimally invasive surgery. A typical example relates to the manually controlled execution of a suture using a terminal tool of the needle-holder type, a needle and a suture. This application can be broadened to any minimally invasive operation requiring that action is undertaken with a tool on a tissue, in an environment of limited space and of very difficult access, at low cost (without requiring the use of an expensive robot). In addition, due to the fact that the actuation and power supply are incorporated as close as possible to the structure of the joints, therefore making it possible to make the manipulator assemblies thus constituted portable, and due to their performance characteristics in terms of force and movement, elementary cells of the bending joint type can also be easily incorporated in electrically powered and controlled limb prostheses (hand, knee, etc.).

The device according to the present invention includes one or more flexible monolithic elements. All these elements can contain different base shapes, for example straight, curved or semicircular beams, bars or blades. Depending on the required performance characteristics, these elements can be optimised from the standpoint of their stiffness, transmissible force and achievable displacements.

Flexible elements, incorporated between the control means (handle or robotic interface, for example) and the distal tool, and arranged and positioned in space, allow one or more motions in any axis aligned relative to the lengthways axis of the device. These flexible elements have a double function. A first function results from the fact that they impart the different degrees of mobility to the flexible structure. A second function results from the internal geometry, which enables: either other flexible elements to be guided which, in a decoupled fashion, are dedicated to the transmission of rotations/torques through the device's lengthways axis, or wires or tubes for the power supply (electric or fluid) to be passed to the elements located downstream, either to deliver medicines, to provide suction, or to enable actuators to be incorporated in them, etc.

FIGS. 1, 2 and 3 illustrates several examples of flexible elements able to be used by the present invention, and which allow bending mobilities.

FIG. 1 shows a flexible element 10 consisting of three hoops 11 in series, where two consecutive hoops are connected by a connecting portion 12. Element 10 has two faces 13 and 14 located at the ends of the flexible element, along the lengthways axis of the flexible element. Face 13 will be, for example, the distal face of the flexible element when it is incorporated in the flexible structure. Face 14 will then be the proximal face of the flexible element. FIG. 1 shows flexible element 10 in an unbent position and in a bent position. This element can be used to impart a unidirectional bend producing a degree of rotary mobility around an axis not parallel to the main axis of the flexible element (10). It is observed that the distal and proximal faces and that the connecting portions 12 are perforated with holes 15, the axis of which is parallel to the lengthways axis of the flexible element. Connecting portions 12 can also be used as stops to limit the bending. As was stated above, this flexible element enables other elements to be guided due to the fact that holes 15 allow, for example, means of transmission of a command, or power command means (for powering) to be passed through them.

FIG. 2 shows a flexible element 20 including three rings 21 positioned in succession along the lengthways axis of the flexible element. Two rings in succession are connected by small columns 22. In this figure all the small columns are located in the same plane, but this arrangement is not always obligatory. FIG. 2 shows flexible element 20 in an unbent position and in positions bending to the left and to the right. This element can be used to impart a bending motion with a degree of bidirectional mobility. It is observed that this element also enables other elements to be guided, since its internal hollow volume allows, for example, command or power transmission means to be passed through it. Flexible element 20 has two faces 23 and 24 located at the ends of the flexible element, along its lengthways axis. Face 23 will be, for example, the distal face, and face 24 will be the proximal face.

FIG. 3 shows a flexible element 30 including three plates 31 positioned in succession along the lengthways axis of the flexible element. Two plates in succession are connected by separated flexible inclined parts 32 and 33. The connection is made on one side of one of the plates to the opposite side of the other plate. This element can be used to impart a bending motion with a degree of bidirectional mobility. FIG. 3 shows flexible element 30 in an unbent position and in positions bending to the left and to the right.

Flexible elements, incorporated in the device between the control means (for example a handle) and the distal tool, allow degrees of translational mobility. Such elements are illustrated by FIGS. 4A, 4B and 5A, 5B. These elements enable a traction motion (respectively a compression motion) directed along an axis in the negative direction (respectively in the positive direction of this axis) to be transformed into an expansion motion in the positive direction of this axis (respectively a contraction motion, in the negative direction of this axis). The conversion factor depends on the geometrical characteristics of the flexible element. These flexible elements act as a motion inverter but also serve to reduce or amplify the actuator norm of displacement. Other unrepresented elements enable the actuator norm of displacement to be amplified or reduced, without reversing the motion.

FIG. 4A shows a first example of a flexible element 40 allowing a degree of translational mobility. This element includes a portion 41 partially attached to the flexible structure (proximal portion) and a distal portion 42, the motion of which is controlled by the actuator (the latter acts on portion 43 of flexible element 40). Distal portion 42 is connected to a following element of the structure which can be a tool. The diagram of FIG. 4B illustrates the operation of the flexible element. This diagram shows a translational movement in the direction opposite to the motion of the actuator.

FIG. 5A shows a second example of a flexible element 50 allowing a degree of translational mobility. This element includes a portion 51 attached to the flexible structure (proximal portion) and a distal portion 52. Reference 53 designates the portion of flexible element 50 connected to the actuator. The diagram of FIG. 5B illustrates the operation of the flexible element.

The device can also include flexible elements, incorporated between the device's control means (for example a handle) and the distal tool, allowing degrees of rotational mobility around the device's lengthways axis.

FIG. 6A shows a first example of a flexible element producing a specific rotary joint of finite angle. Flexible element 60, shown at rest in FIG. 6A, where it is associated with a bellows-shaped rigid part 64, includes two circular plates which are positioned parallel to one another: a proximal plate 61 and a distal plate 62. The two plates are connected by inclined elastic tabs 63 positioned at their periphery. Flexible element 60 can be actuated by an actuator passing through a central hole of plate 61, and connected to plate 62.

FIG. 6B shows flexible element 60 in a deformed position. The deformation has been obtained by the collapse of elastic tabs 63 under the effect of an actuator connected to plate 62, which causes a rotary action. The rotation of the plate 62 of flexible element 60 can be clearly seen by comparing the alignment of part 64 installed in plate 62.

FIG. 7 shows a second example of a flexible element producing an intrinsic rotary joint of finite angle, where the flexible element is at rest. This monolithic flexible element 70 consists of two superimposed and securely attached elementary flexible elements 60 (see FIG. 6A). Flexible element 70 can be actuated by an actuator passing inside elementary flexible elements 60, and connected to the upper plate of the upper elementary flexible element.

The device according to the invention may also include other flexible elements, incorporated between the control means (for example a handle) and the distal tool of the device according to the invention, where these flexible elements can be guided partially inside other flexible elements, or externally, surrounding these flexible elements. Examples of such flexible elements are represented in FIGS. 8 and 9. They can be used to transmit a rotation of infinite angle, or a torque along the lengthways axis of the device according to the invention, or along the flexible elements through which they pass.

FIG. 8 shows a flexible element constituted by a helical spring 80 with circular wire section (see the enlarged part of the figure).

FIG. 9 shows a flexible element constituted by a helical spring 90 with rectangular wire section (see the enlarged part of the figure).

FIG. 10 shows a surgical device 100 according to the invention in use through a patient 101. Device 100 includes a control handle 102 extended by a rod 103 on which is installed a motor 104 the purpose of which is to drive, rotationally, a flexible element such as those represented in FIGS. 1 to 7, 12A to 13B, 17, 18 and 20 to 30 through a flexible element such as those represented in FIGS. 8, 9 and 11. From interface 105 between the exterior and the interior (patient), rod 103 is extended by a structure 106 terminated by a distal tool 107. The fact that structure 106 is traversed wholly or partly by one or more flexible elements such as those represented in FIG. 8 or 9 allows a torque to be transferred from motor 104 through several flexible elements which constitute structure 106, and in particular bending elements.

FIG. 11 represents an example of a flexible structure 110 including a first flexible element 111, constituted by a spring, positioned freely inside a second flexible element 112, also constituted by a spring, but which is shorter than the first. Such a structure enables two decoupled rotations, each initiated by an unrepresented rotary actuator, to be transmitted coaxially, where the first rotation causes, via spring 111, motion in an element (not represented in FIG. 11) located downstream from the element (not represented in FIG. 11) moved by the second rotation (spring 112).

The surgical device can include other elements, whether or not flexible, acting as the distal tool, and associated with the other flexible elements (for example bending, translational, rotary or rotation/torque-transmitting). FIGS. 12A, 12B and 13A, 13B show two examples of flexible tools, in perspective (FIGS. 12A and 13A), and from the front (FIGS. 12B and 13B).

FIGS. 12A and 12B illustrate a model of a flexible monolithic clamp 120 including two rigid jaws 121 and 122. FIG. 12B shows how the clamp closes under the action of the actuator.

FIGS. 13A and 13B illustrate a model of a flexible needle-holder 130. FIG. 13B shows how the needle-holder opens under the traction action produced by the actuator.

The device can also include one or more fluid actuators/transducers, remotely deployed or locally incorporated in terms of the device's degrees of mobility, to control the motion of the flexible elements. A fluid actuator will now be described in relation to FIGS. 14, 15, 16A, 16B and 16C.

FIG. 14 represents, from a perspective view, a fluid muscle of the McKibben type intended to act as a fluid actuator. This fluid actuator consists of an elastic membrane (not visible in FIG. 14 but referenced 141 in FIG. 15), which is closed and sealed. Membrane 141 has the shape of a tube closed at its ends by disks 142 and 143 intended to transmit the forces produced by the fluid muscle. Reference 144 designates a fluid inlet aperture (air, water, oil, physiological fluid, etc.).

Membrane 141 is covered by an element 145 which restricts its radial expansion such that it is in relation with its axial contraction. This may be a braided sheath manufactured with non-extensible threads which form an angle θ relative to one another. Examples of such braids are represented in FIGS. 16A to 16C. The materials for the membrane may be, for example, polymers or elastomers (silicon, latex, etc.). The materials for the element which restricts the radial expansion of membrane 141 such that it is in relation with its axial contraction may be, for example, polymers, organic materials, metals or mineral materials (PET, nylon, glass fibre, carbon fibre, etc.). When the volume of the fluid inside membrane 141 is increased, the volume of this membrane increases, as does the pressure, in the manner of a balloon, pushing the braided sheath radially. The sheath, which is non-extensible, reacts to this increase of volume by modifying braiding angle θ to attempt to maintain its cylindrical shape. Since the extensible membrane and the sheath are connected to the ends, and are pressurised, the muscle shortens, slightly increasing its diameter, and produces a traction force if the muscle is attached to a resistive mechanical load.

The device according to the invention may include one or more fluid supply systems to supply each fluid actuator in selective fashion. The supply system may consist of a tank and of its actuation means. Control may be manual, or obtained by electric, thermoelectric, piezoelectric or mechanical means, means involving shape-memory materials, intelligent materials, volume- or phase-change materials, or others. With the aim of incorporating the supply system in the instrument a closed fluid circuit will be used (for example, by using a dedicated power unit, which may include a tank and/or a transducer transforming the supplied power, for example electrical power, into another form of energy, for example mechanical energy). This system may be used remotely (on the rod or the handle, etc.) or it may be incorporated locally, being positioned next to the fluid actuators and the joints to be controlled.

FIGS. 17 and 18 show two possible configurations of the power unit of a volume-change actuator of the fluid type, for controlling the motion of flexible element 10 described in FIG. 1.

FIG. 17 represents a flexible unit 170 consisting of flexible element 10 and of a fluid actuator 140 as represented in FIG. 14. Fluid actuator 140 has at least one of its ends attached to at least one of the respective ends of flexible element 10. Under the effect of a command, McKibben-type fluid actuator or fluid muscle 140 can thus shorten and cause flexible element 10 to bend, as shown in the right-hand part of FIG. 1. It is observed that holes 15 of flexible element 10 are sufficiently large to allow muscle 140 to expand radially.

In the case of flexible unit 170 represented in FIG. 17, the fluid supply system (consisting of all of elements 171, 172 and 173) of the actuator is incorporated in the flexible unit (and is therefore closely related to the actuator). Reference 171 designates a fluid tank which communicates with the interior of muscle 140. Reference 172 designates an actuator of the tank. Reference 173 designates a pressure sensor for measuring the pressure of the fluid inside the muscle's fluid circuit (in this case, inside tank 171).

In the case of the flexible unit represented in FIG. 18, the fluid supply unit is remotely deployed relative to flexible unit 170. A flexible fluid supply pipe 181 connects the interior of muscle 140 to power unit 182 which is remotely deployed in the rod or handle, or externally. A pressure sensor may be incorporated in different locations in the fluid circuit.

FIG. 19 is a lengthways section view of a variant of a McKibben-type muscle able to be used for the device according to the invention. Muscle 190 is actuated by means of a volume-change material. It consists of a tubular sheath 191 (a flexible, sealed membrane, the radial expansion of which is related to its axial contraction, as with the McKibben-type muscle), for example a braided sheath made of carbon embedded in latex, plugged at both ends by stoppers 192. Sealing may be obtained, for example, by means of seals 193. The internal volume of the muscle, possibly completed by a closely related tank, is filled with a volume-change material 194, for example a wax. The muscle is actuated, for example, by passing an electric current in conductive wire 195 (an electrical resistor), which when it heats will cause a change of volume of material 194, and either an expansion or a contraction of it. This actuation may be obtained by other means, for example chemical, thermal, means, etc.

One or more pressure sensors may be incorporated locally in the fluid or volume-change actuators/transducers, in order to measure in a proprioceptive manner (i.e. in situ) the change of pressure within each fluid or volume-change actuator, and to estimate the forces of interaction with the environment. In FIG. 17 such a pressure sensor has been represented as reference 173.

One or more multiple-axis pressure and/or force or touch sensors may be incorporated locally in the end effectors (for example, clamps, needle-holders, etc.), or at the periphery of the elements of the device (rod, flexible elements, etc.) to measure in an exteroceptive manner the forces of interaction with the environment (for example the clamping force of a clamp, a shearing force), or a multiaxial force of contact with adjacent organs. These sensors, or deformation sensors, may also be incorporated locally in the flexible structures to estimate the state of the device by proprioceptive measurement.

One or more motors can be remotely deployed outside the distal and/or intracorporeal portion of the device in order to transmit an axial rotation, possibly via a flexible structure, as illustrated by FIG. 10.

The device according to the invention is of modular design, where different flexible base units provide the different degrees of flexibility (passive flexible elements) or of mobility (actuated flexible units). FIGS. 17 and 18 give an example of a flexible unit of the joint type with a unidirectional bending degree of mobility. FIGS. 20 and 21 give two examples of a flexible unit of the joint type with a bidirectional bending degree of mobility.

FIG. 20 shows a flexible element 20 (previously shown in FIG. 2) fitted with two fluid muscles 140 (previously shown in FIG. 14) to provide a flexible unit 200. Muscles 140 connect at least one of the upper and lower rings of flexible element 20 traversing the central ring.

FIG. 21 shows a flexible element 30 (previously shown in FIG. 3) fitted with two fluid muscles 140 (previously shown in FIG. 14) to provide a flexible unit 300. Muscles 140 connect at least one of the upper and lower plates of flexible element 30 traversing the central plate.

The flexible units of the device according to the invention can have a degree of rotary mobility in the distal portion, and therefore acquire two degrees of mobility (bending and transmission of a torque/rotation).

FIGS. 22A to 22D illustrate a flexible unit 220 with two degrees of freedom (bending and transmission of a torque/rotation). This flexible unit is of the type 170 represented in FIGS. 17 and 18, i.e. including a flexible element 10 and a muscle 140. It also includes a helical spring 80 positioned between faces 13 and 14 of flexible element 10, and surrounding the fluid actuator.

A distal tool shown in the form of a bellows 222 for the sake of explanation is attached on the side of distal face 13 of flexible element 10 (see FIGS. 22B to 22D) and installed securely attached with spring 80. In these figures, when the base of the spring on the side of face 14 rotates through a quarter of a revolution, distal tool 222 also rotates through a quarter of a revolution, giving flexible element 10 the possibility of bending.

Several flexible units can be connected in series, and nevertheless allow a distal rotation through the use of a flexible element for transmission of rotation traversing these units. This is shown by FIGS. 23A and 23B, where two flexible units 170 are installed securely attached in series and angularly offset by 90°. Associated in parallel with a rotation transmission spring 80, they form an assembly 230 which produces two bends in different planes and allows a distal rotation produced by a rotary actuator (not represented in the figure) to be transmitted, without any coupling or disturbance of the actions of the traversed flexible units.

FIG. 24 shows another example of a series connection of two flexible units 200 allowing transmission of a distal torque supplying an assembly 240. A spring 80 traverses both flexible units 200 and is attached to an upper plate to cause a distal tool (not represented in the figure) installed on this plate to rotate.

One of the advantages of the present invention lies in the possibility of adding a degree of rotational mobility in series (for example, placed between two bending or translational joints). FIGS. 25A and 25B show two flexible units connected in series, with transmission of a distal torque and relative rotation between flexible units 200, supplying an assembly 250. Two concentric springs are used: a first spring 251 (in this case the internal spring) controls the degree of distal rotation; a second spring 252 (in this case the external spring) controls the rotation of upper flexible unit 200. In this case the rotation can be of infinite angle. A flexible rotary joint can also be used between the two bending joints (as in FIGS. 6A, 6B and 7). In this case the rotation will be of finite angle.

FIGS. 26A to 27B illustrate two examples of flexible units of the tool type, i.e. units resulting from the association of a flexible tool and an actuator.

FIGS. 26A and 26B show a flexible unit of the tool type 260 including a flexible clamp 120 controlled by a fluid actuator 262 positioned inside a protective sleeve 263. In FIG. 26B, protective sleeve 263 is represented as a section view so as to show fluid actuator 262. The action of actuator 262 (see FIG. 26B) causes jaws 261 of the clamp to close, as indicated by the arrows.

FIGS. 27A and 27B show a tool unit 270 including a flexible needle-holder 271 controlled by a fluid actuator 272 positioned inside a protective sleeve 273. In FIG. 27B, protective sleeve 273 is represented as a section view so as to show fluid actuator 272. The action of actuator 272 (see FIG. 27B) causes the two jaws 274 of the needle-holder to open, as indicated by the arrows.

As an illustration, FIGS. 28A to 28C represent different views of a portion of a surgical device according to the invention including an assembly 230 (see FIG. 23A) associated with a flexible unit of the tool type 260 including a clamp 120 (see FIGS. 26A and 26B), the actuator of which is incorporated locally. This device has two degrees of unidirectional bending mobility, with a transmission of distal rotation/torque which allows clamp 120 to be rotated around the axis of the device.

FIGS. 29A and 29B represent a portion of a surgical device according to the invention including an assembly 250 (see FIGS. 25A and 25B) associated with a flexible unit of the tool type 260 (see FIGS. 26A and 26B) including a clamp 120. This device has two degrees of bidirectional bending mobility with, in addition, a transmission of a distal rotation/torque (enabling the tool to be pivoted) and a relative rotation of the flexible units. In FIG. 29B the assembly is shown partially as a section view.

FIG. 30 represents a flexible unit of the rotary joint type 280 using a fluid muscle wound around a shaft. This joint consists of a muscle 281 wound in a helix around a shaft 282 which forces the internal diameter of the helix to remain constant. The assembly constituted by shaft 282 and muscle 281 is inserted in a rigid tube 283 shown as a lengthways section. The lower end of muscle 281 is attached to tube 283, while its upper end is attached to shaft 282. When it contracts the muscle thus produces a relative rotary motion of shaft 282 relative to rigid tube 283, around their common axis. The joint also includes two spiral springs 284 and 285 connecting the shaft to the tube, and acting as a flexible guide of shaft 282 relative to tube 283. Other flexible guidance devices can be used. However, it is preferable not to use bearings, in order that the device remains compact, light, sterilisable and of low cost. Springs 284 and 285 also enable an elastic restoring force to be exerted when the muscle is extended. Unlike the flexible elements described, for example, in FIGS. 1 to 7 (translation, bending, rotation and coupled motions functions), the function of these flexible guides is not to transform the motion of the actuator, but to guide it.

The device can be fitted with a very flexible outer membrane enabling the flexible elements and units, the actuators, the electrical power cables and the connection technology to be isolated from the exterior.

### Description of an Artificial Hand

FIGS. 31A and 31B represent an artificial hand according to the present invention. FIG. 31A represents the artificial hand with stretched fingers, whilst FIG. 31B represents the artificial hand with a slightly bent finger.

Artificial hand 300 represented in FIGS. 31A and 31B includes five fingers. The fingers include flexible units with localised actuators and a localised dedicated power unit 170 (see FIG. 17) between each phalanx 301. The first phalanx of the thumb is also connected to the remainder of the hand by a flexible unit 170.

Phalanges 301 incorporate elements 171, 172 and 173, which can be seen in FIG. 17, i.e. a fluid tank 171, an actuator 172 of the fluid tank and a pressure sensor 173 to measure the pressure of the fluid inside tank 171. It is observed that in respect of the thumb the remainder of the hand incorporates elements 171, 172 and 173 of flexible unit 170 connecting the first phalanx of the thumb to the remainder of the hand.

1. An integrated mecatronic structure for a manipulator assembly with one or more degrees of mobility controlled by one or more actuators, which is able to impart to the manipulator assembly a motion activated by control means connected to actuation means, including flexible units, where each flexible unit consists of at least one flexible element attached to at least one volume-change actuator,
wherein the volume-change actuator is associated with a closely related or local dedicated power unit, including a tank and the actuation means able to make the manipulator assembly portable.

2. The structure according to claim 1, in which the volume-change actuator, or its tank, includes a syringe, a piston, a jack or a bellows.

3. The structure according to claim 1, in which the volume-change actuator, or its tank, contains a volume-change material.

4. The structure according to claim 1, in which the volume-change actuator includes a sealed, flexible tube, containing a volume-change material, and a sheath or rigidification element surrounding the tube, or embedded in the wall of the tube, and radially constricting the deformation of the tube in a direction transverse to the lengthways axis of the actuator, and in relation with the actuator's lengthways deformation.

5. The structure according to claim 1, in which the volume-change actuator is a fluid actuator (140).

6. The structure according to claim 5, in which a closed tank containing fluid required for operation of the fluid actuator is deployed remotely, and connected to the actuator by a fluid supply tube, where this tube is flexible.

7. The structure according to claim 1, in which a pressure sensor is associated with the volume-change actuator, or with its closely related tank, to measure the pressure inside the volume-change actuator, and to deduce from it the forces of interaction between the structure and its environment.

8. The structure according to claim 1, in which the mecatronic structure includes at least one additional flexible unit and/or at least one additional flexible element, such that it gives the device several degrees of mobility, where the additional flexible unit or units and the additional flexible element or elements can be associated in series, in parallel or in a tree structure with the flexible unit.

9. The structure according to claim 1, in which an additional flexible element associated in series, in parallel or in a tree structure with the flexible unit transmits, without coupling with this flexible unit or disturbing the motion of the structure, a torque or a rotary motion through the structure produced by a remotely deployed actuator which is not connected to the flexible unit.

10. The structure according to claim 9, in which the additional flexible element transmitting a torque or a rotary motion is a spring, a bellows or a flexible shaft.

11. The structure according to claim 1, in which at least one of the flexible element, and the additional flexible element, is an element consisting of the fixed arrangement of several shapes of flexible base chosen from among a beam, a bar, a small column, a blade, a tab, a curved beam, a curved bar, a curved small column, a curved blade, a curved tab, an arch, a helix, a spiral and a flexible shaft.

12. The structure according to claim 1, in which the flexible element or, possibly, the additional flexible element is an element causing a bending or rotary or translational motion in the flexible portion of the structure.

13. The structure according to claim 1, in which the flexible element or, possibly, the additional flexible element is an element causing a coupled motion in the flexible portion of the structure, combining at least two motions chosen from among: a bending motion, a rotation and a translational motion.

14. The structure according to claim 1, in which the flexible element or, possibly, the additional flexible element is an element constituting a flexible guide.

15. The structure according to claim 1, in which the flexible element or, possibly, the additional flexible element is a surgical tool, for example a clamp.

16. The structure according to claim 1, also including a rotary joint including a shaft and a volume-change muscle wound in a helix around the shaft, and securely attached, by a first end, to the said shaft and, by a second end, to the structure, where the volume-change muscle is able to cause the shaft to rotate under the effect of a command.

17. The structure according to claim 1, in which the element to convert the supplied power into another form of energy is another actuator or a transducer.

18. The structure according to claim 1, in which the actuator, possibly coupled to a mechanical transmission system, is chosen from among: a wire or a strip made of a shape-memory alloy, a shape-memory actuator, an electromagnetic motor, a piezoelectric actuator, an ultrasound motor, a magnetostrictive actuator and an electroactive polymer.

19. The structure according to claim 1, in which the means of actuating or controlling the actuator are chosen from among manual actuation or control means, and motorised actuation or control means.

20. The structure according to claim 1, in which the structure includes at least one flexible unit or one installable, easy-assembly, disposable or interchangeable flexible element.

21. The structure according to claim 1, fitted with at least one external or internal sensor, able to provide information to a user concerning a temperature, an electric current, a motion made or a force produced by a component of the manipulator assembly on its environment.

22. The structure according to claim 21, in which the external sensor is a sensor chosen from among a single-axis or multiple-axis force sensor measuring a shearing and/or clamping force, or a touch sensor measuring a contact force, exerted by one or more elements of the structure (a surgical tool or another flexible unit of the structure) on its environment (an organ, a region of a patient's body or a manipulated object).

23. The structure according to claim 7, including a control system receiving data from at least one sensor to control and/or limit the motion and/or forces produced by the device on its environment.

24. The structure according to claim 1, in which the actuator is attached to an articulated structure.

25. The surgical device to accomplish surgical actions requiring dexterity on an organ or a region of the body of difficult access, and under minimally invasive conditions, including a structure according to claim 1, where the first end of the structure is a proximal end for the device, and where the structure may include at its distal end a surgical tool and/or a means of exploration able to be actuated from the control means by actuation means.

26. The surgical device according to claim 25, in which the control means are chosen from among a mechanical or motorised actuation handle, a remote operation interface, possibly with force feedback, or a surgical robot arm.

27. The surgical device according to claim 25, in which a viewing means is attached to the structure's distal end.

28. The artificial hand including at least one finger including flexible units, where each flexible unit consists of at least one flexible element attached to at least one volume-change actuator,
wherein the volume-change actuator is associated with a closely related or local dedicated power unit, including a tank and the actuation means able to make the manipulator assembly portable, where the hand is intended to be installed at the end of the arm of a patient or of a robot.

29. The artificial hand according to claim 28, in which the control means are electronic control means, possibly with force feedback.

30. The artificial hand according to claim 29, in which the electronic control means are means using electroencephalography techniques and/or signals, and/or electromyography techniques and/or signals.

31. The structure according to claim 23, in which the external sensor is a sensor chosen from among a single-axis or multiple-axis force sensor measuring a shearing and/or clamping force, or a touch sensor measuring a contact force, exerted by one or more elements of the structure (a surgical tool or another flexible unit of the structure) on its environment (an organ, a region of a patient's body or a manipulated object).

32. The structure according to claim 23, fitted with at least one external or internal sensor, able to provide information to a user concerning a temperature, an electric current, a motion made or a force produced by a component of the manipulator assembly on its environment.
